(19) United States
(12) Patent Application Publication
(10) Pub. No.: US 2012/0067119 A1
(43) Pub. Date: Mar. 22, 2012

(54) PRESSURE-SENSOR BASED LIQUID-LEVEL MEASURING DEVICE WITH REDUCED CAPILLARY EFFECT

(75) Inventors: John Cronin, Mahopac, NY (US); Gary C. Helstern, Newtown, CT (US); Merima Jahic, New Milford, CT (US); Seth Kacur, Beacon, NY (US)

(73) Assignee: DIBA INDUSTRIES, INC., Danbury, CT (US)

(21) Appl. No.: 13/319,794

(22) PCT Filed: May 26, 2010
(86) PCT No.: PCT/US10/36160

§ 371 Date: Nov. 10, 2011

Related U.S. Application Data
(60) Provisional application No. 61/181,105, filed on May 26, 2009.

(51) Int. Cl. G01F 23/14

(52) U.S. Cl. 73/299

(57) ABSTRACT

A high efficiency diametrically compact, radial oriented piston hydraulic machine includes a cylinder block with a plurality of cylinders coupled to a first port by a first valve and to a second port by a second valve. A drive shaft with an eccentric cam, is rotatably received in the cylinder block and a cam bearing extend around the eccentric cam. A separate piston is slideably received in each cylinder. A piston rod is coupled at one end to the piston and a curved shoe at the other end abuts the cam bearing. The curved shoe distributes force from the piston rod onto a relatively large area of the cam bearing and a retaining ring holds each shoe against the cam bearing. The cylinder block has opposing ends with a side surface there between through which every cylinder opens. A band engages the side surface closing the openings of the cylinders.

The present disclosure relates to liquid-level sensors and, more particularly, to devices comprising pressure sensors for sensing levels of liquids in containers.

Conventional liquid-level sensors are available with a variety of designs and configurations. Examples of such sensors include float switches, conductive sensors, capacitive and ultrasonic sensors, radio-frequency (RF) emitting sensors, light-emitting level sensors, vibrating forks and thermal-dispersion sensors, differential-pressure sensors, bubblers, displacers, and load cells. The simplest conductive sensors have the disadvantage of being able to sense only one level of a liquid within a container. Though other conventional sensors such as capacitive sensors, RF-emitting sensors, bubblers, and the like, may be capable of continuously sensing a liquid level within a container, such sensors tend to be expensive and typically require sophisticated electronic systems to monitor the fluid level continuously. As such, there exists a need for sensors that can continuously sense liquid levels within containers, that are relatively inexpensively manufactured and sold, in comparison with conventional options, and that do not require sophisticated electronic systems for their operation.

In example embodiments, a device for sensing or monitoring a level of a liquid within a container comprises a pressure sensor body and a hollow tube. The pressure sensor body comprises a sensing element. The hollow tube comprises a first end having a substantially air-tight connection to the pressure sensor body and further comprises a second end opposite the first end. The hollow tube further comprises a narrow portion extending from the first end and having a first inside diameter, a wide portion extending from the second end and having a second inside diameter greater than the first inside diameter, and a transition portion connecting the narrow portion and the wide portion. An inner column is defined within the hollow tube, extending through the hollow tube from the first end to the second end. The inner column is in fluid communication with the sensing element. During operation of the device, while the second end of the hollow tube is immersed in the liquid, a portion of the liquid extends into the inner column up to a column liquid level. Any change in the column liquid level causes a change in pressure to a substantially constant mass of gas contained within the inner column. This change in pressure is measurable by the sensing element and is directly related to the level of the liquid in the container.

These and other features, aspects, and advantages of the present invention will become better understood with reference to the following description, appended claims, and accompanying drawings.

Though the specification concludes with claims particularly pointing out and distinctly claiming the invention, it is believed that the present invention will be better understood from the following description taken in conjunction with the accompanying drawings, in which:

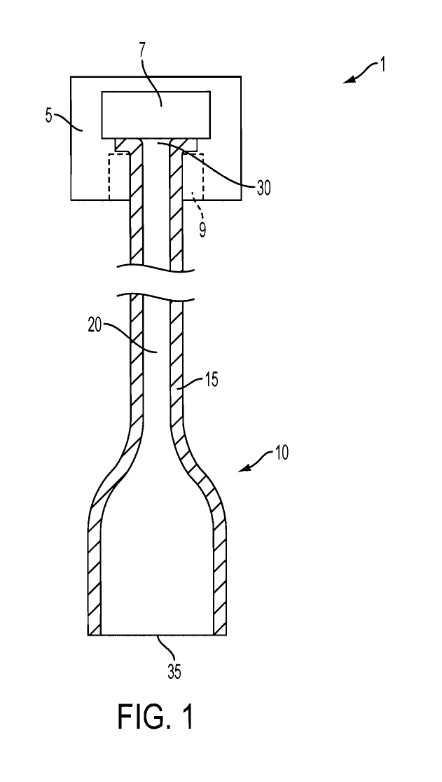

FIG. 1 is a cut-away view of a device for sensing a level of a liquid in a container, according to embodiments described herein;

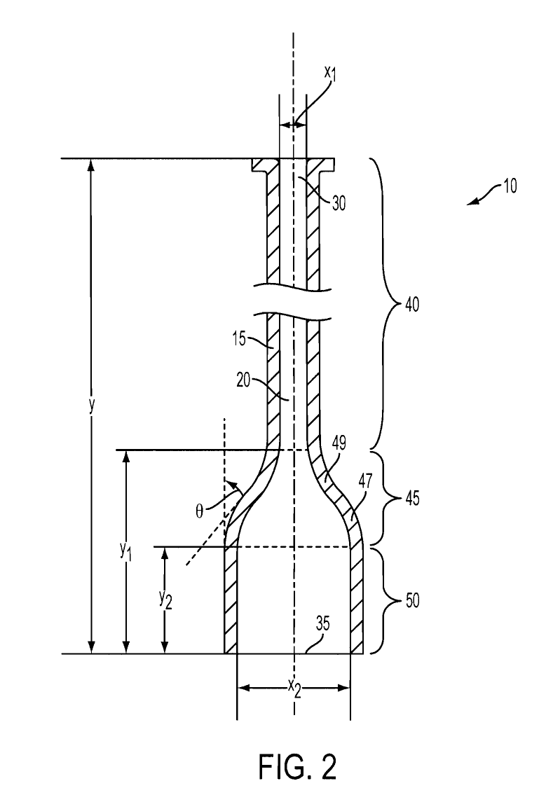

FIG. 2 shows a hollow tube of a device for sensing a level of a liquid in a container, according to example embodiments; and

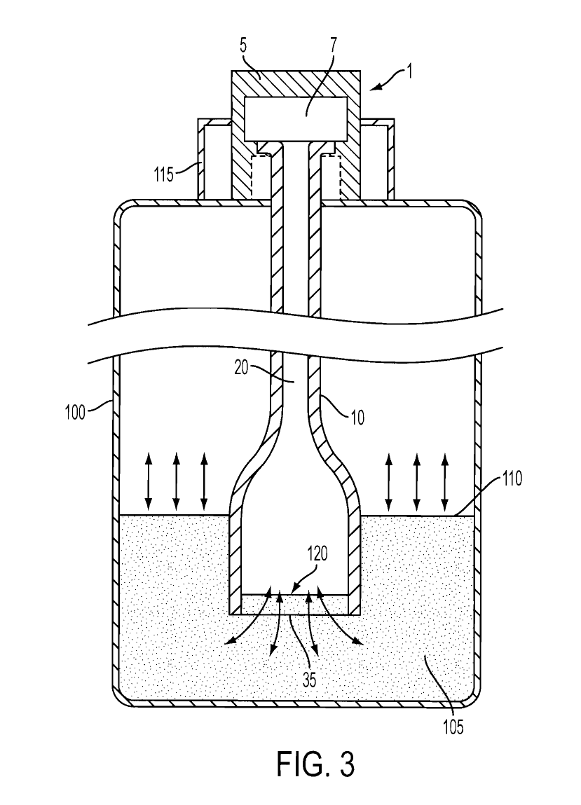

FIG. 3 shows an example embodiment of a device for sensing a level of a liquid, when the hollow tube of the device is immersed in a liquid within a container.

Features and advantages of the invention will now be described with occasional reference to specific embodiments. However, the invention may be embodied in different forms and should not be construed as limited to the embodiments set forth herein, even if the embodiments are described as “preferred.” Rather, these embodiments are provided so that this disclosure will be thorough and complete and will fully convey the scope of the invention to those skilled in the art.

Unless otherwise defined, all technical and scientific terms used herein have the same meaning as commonly understood by one of ordinary skill in the art to which the invention belongs. The terminology used in the description herein is for describing particular embodiments only and is not intended to be limiting. As used in the specification and appended claims, the singular forms “a,” “an,” and “the” are intended to include the plural forms as well, unless the context clearly indicates otherwise. As used herein, the term “about” is intended to account for errors inherent with any measurement of a physical quantity. Unless otherwise noted, a physical quantity modified by the word “about” will be understood to encompass any deviation of up to ±10% from the explicitly mentioned quantity so modified.

Embodiments of the present disclosure relate to devices for sensing or monitoring a level of a liquid within a container. The devices comprise components utilizing a simple physics principle that a specified mass of air with an initial volume V₁ and an initial pressure P₁ may be compressed or expanded to a second volume V₂ at a second pressure P₂. For the specified mass of air, the pressure is inversely proportional to volume, such that for every P₂ and V₂, P₁V₁=P₂V₂. That is, as volume decreases, pressure increases, and as volume increases, pressure decreases.

If the specified mass of air is present in an otherwise air-tight, hollow tube having one open end immersed in a liquid, a small amount of liquid will enter into the hollow tube through the open end, even though no air can be displaced from the air-tight hollow tube. The amount of liquid that enters the hollow tube is directly related to the depth to which the hollow tube is immersed in the liquid. As the liquid level rises in the hollow tube through the open end, the volume of the specified mass of air will decrease and the pressure of the specified mass of air will increase. The liquid level in the hollow tube is directly related to the pressure of the air inside the hollow tube, because as the liquid level increases, the pressure measurably increases also, even if only very slightly. Likewise, as the liquid level decreases, the pressure measurably decreases also. In principle, the effect is analogous to placing one's finger over one end of a drinking straw, inserting the other end of the drinking straw into a beverage, and noting that a small amount of the beverage enters into the drinking straw. The small amount is considerably less than the amount that would have entered had the finger had not been placed over the end outside the beverage. But even with a finger over one end of the drinking straw, the farther the drinking straw is submerged into the beverage, the greater the amount of liquid enters into the drinking straw.

The accuracy and reproducibility of pressure measurements made from a hollow tube, described above in principle only for illustration, can be affected adversely by phenomena such as capillary activity of the hollow tube itself and changes in ambient temperature or pressure of the liquid in the container. Embodiments described in the present disclosure provide solutions to the problems encountered by a pressure-sensor based liquid-level detection device having a hollow tube. The problems include, for example, capillary activity of the hollow tube itself, temperature changes to the liquid and ambient environment, and pressure changes within a container holding the liquid.

Referring to the example embodiment shown in FIG. 1, a device 1 for sensing or monitoring a level of a liquid in a container comprises a pressure sensor body 5. The pressure sensor body 5 comprises a sensing element 7. The device 1 further comprises a hollow tube 10 with a first end 30 and a second end 35 opposite the first end 30. The hollow tube 10 has an inner column 20 defined therein, and the inner column 20 extends from the first end 30 of the hollow tube 10 to the second end 35 of the hollow tube 10. The inner column 20 is in fluid communication with the sensing element 7, such that the sensing element 7 is operable to detect changes in pressure of gas within the hollow tube 10. Thus, the device 1 is appropriate both for one-time measurements of a liquid level and for constant monitoring of a liquid level over a desired period of time.

The pressure sensor body 5 itself may have any desired or convenient shape or configuration, and the sensing element 7 may be any type of pressure sensor known in the art. In non-limiting example embodiments, the sensing element 7 may be a capacitive or piezoresistive sensor comprising, for example, a diaphragm. In such examples, the sensing element 7 is operable to detect changes of pressure of constant volume of gas contained within the hollow tube 10 concurrent with rising and lowering liquid levels within the hollow tube 10. In further examples, the pressure sensor body 5 may be electrically connected to monitoring means (not shown) such as, for example, an electronics controller, computerized equipment, or devices useful for recording fluid levels at specified time intervals.

The hollow tube 10 may comprise any suitable material, but from a practical standpoint should be chemically and physically compatible with the liquid for which sensing or monitoring of a liquid level is intended. As used herein, “chemically and physically compatible” means that the hollow tube 10 shows no tendency to react with the liquid or to deform in any manner when exposed to the liquid at the temperature and pressure of the environment in which the liquid level is being measured. Some applications may require the hollow tube 10 to be chemically and physically compatible with corrosive reagents or hazardous waste liquids, for example. As such, the hollow tube 10 may be formed from chemically inert materials. The inert materials are advantageous over stainless steel, for example, because even stainless steel may degrade in corrosive environments and may require frequent replacement. Frequent replacement of sensors can result in increased potential for contamination of the area where the hazardous material container is stored.

In some embodiments, the hollow tube 10 may comprise a material impervious to air or substantially impervious to air. As used herein, “substantially impervious to air” means that the walls of the hollow tube 10 are sufficiently impervious to air such that no leakage of air through the walls of more than 0.25 mL will occur during any 24-hour period, at the ambient temperature and pressure for a particular application of the device 1, when the second end 35 of the hollow tube 10 is immersed in a liquid. When the hollow tube 10 is at least substantially impervious to air, gas contained within the inner column 20 tends not to escape the hollow tube 10 laterally through walls of the hollow tube 10. Such an escape of gas may adversely affect the consistency of pressure measurements by the sensing element 7. In further embodiments, the hollow tube 10 may comprise a material having a sufficiently low surface energy to ensure that the liquid being measured can flow freely when in contact with the walls of the hollow tube 10 defining the inner column 20. In still further embodiments, the hollow tube 10 may comprise any material having one or more of the above features. In a specific example, the hollow tube 10 may comprise Teflon (polytetrafluoroethylene).

The first end 30 of the hollow tube 10 has a substantially air-tight connection to the pressure sensor body 5. As used herein, “substantially air-tight connection” means that the connection is sufficiently air-tight such that no leakage of air through the walls of more than 0.25 mL will occur during any 24-hour period, at the ambient temperature and pressure for a particular application of the device 1, when the second end 35 of the hollow tube 10 is immersed in a liquid. In terms of performance and reproducibility, however, it may be desirable for the connection of the first end 30 of the hollow tube 10 to the pressure sensor body 5 to be completely air-tight or as nearly completely air-tight as technically feasible. A substantially air-tight connection between the first end 30 of the hollow tube 10 and the pressure sensor body 5 may be accomplished by any practical means.

As a non-limiting example, FIG. 1 shows a connection element 9 adjacent to the first end 30 of the hollow tube 10. The connection element 9 may comprise any sealing means known in the art, such as a rubber o-ring seal or a gasket of a suitable material. Though the first end 30 of the hollow tube 10 is shown in FIG. 1 as flared, it will be understood that a flared end represents only one of many possible configurations for the hollow tube 10 that aids the establishment of a substantially air-tight connection of the hollow tube 10 to the sensing element 7, in combination with the connection element 9. The connection element 9 may be integral with the hollow tube 10, with the pressure sensor body 5, or both. For example, the connection element 9 may comprise a snap-in feature (not shown) integral with the pressure sensor body 5, such that the hollow tube 10 can be inserted into the snap-in feature to form a substantially air-tight connection. As another example, the connection element 9 may comprise a threaded connection (not shown) integral with the hollow tube 10 and operable to be screwed into threads (not shown) of the pressure sensor body 5 to form the substantially air-tight connection. As still another example, the connection element 9 may comprise a plug (not shown) of a material such as an epoxy that is inserted into a hole (not shown) in the pressure sensor body 5 slightly larger than the hollow tube 10.

Referring with particularity to FIG. 2, the hollow tube 10 further comprises a narrow portion 40 extending from the first end 30, a wide portion 50 extending from the second end 35, and a transition portion 45 connecting the narrow portion 40 and the wide portion 50. The narrow portion 40 has a first inside diameter x₁, and the wide portion 50 has a second inside diameter x₂, such that x₂ is greater than x₁. The absolute magnitude of x₁ is in no way critical to the function of the device 1, but in specific non-limiting examples, the first inside diameter x₁ may range from about 0.3 cm, for example, in devices for use in very small containers with capacities of less than about 5 mL to 50 mL, to about 10 cm, for example, in devices for use in very large containers having capacities of 20 L to 500 L or more.

In the non-limiting example embodiment shown in FIG. 2, x₁ and x₂ are essentially constant through the narrow portion 40 and the wide portion 50, respectively such that the narrow portion 40 and the wide portion 50, as well as the inner column 20 within both the narrow portion 40 and the wide portion 50, are essentially cylindrical. As used herein, “essentially constant” and “essentially cylindrical” mean that the applicable inside diameter varies less than 5% from an average value determined by measuring the inside diameter at all points along the length of the applicable portion of the hollow tube 10. When both the narrow portion 40 and the wide portion 50 are essentially cylindrical, the ratio (x₂/x₁) of the second inside diameter x₂ to the first inside diameter x₁ may range from about 4:1 to about 10:1, from about 4:1 to about 8:1, from about 4:1 to about 6:1, from about 6:1 to about 10:1, from about 6:1 to about 8:1, or from about 8:1 to about 10:1. In a specific example, the ratio x₂/x₁ may be about 6:1.

In embodiments not shown in FIG. 2, x₁, x₂, or both, may vary along the length of the narrow portion 40, the wide portion 50, or both, respectively, by up to 25%, up to 20%, up to 15%, or up to 10% from an average value for x₁ or x₂, as applicable, determined by measuring the inside diameter at all points along the length of the applicable portion of the hollow tube 10. In other embodiments not shown, the variance of the inside diameters x₁ and x₂ may result in a progressive increase along the length of the hollow tube 10, such that in the direction from the first end 30 to the second end 35, x₁, x₂, or both, only increases but never decreases. In still other embodiments not shown, x₂ may increase along the length of the wide portion 50 such that the wide portion 50 has a trapezoidal cross-section with an inside diameter of the wide portion 50 at the interface with the transition portion 45 being smaller than the inside diameter at the second end 35. In specific examples with a trapezoidal cross-section, the inside diameter of the wide portion 50 at the interface with the transition portion 45 may be 75%, 80%, 85%, 90%, or 95% of the inside diameter of the wide portion 50 at the second end.

The transition portion 45 connects the narrow portion 40 to the wide portion 50 such that the inside diameter of the inner column 20 is x₁ where the transition portion 45 meets the narrow portion 40 and is x₂ where the transition portion 45 meets the wide portion 50. In the example embodiment shown in FIG. 2, the transition portion 45 has a bell shape characterized by two smooth curves, shown as inward curve 47 and upward curve 49, each defining angles of curvature. The inward curve 47 represents the connection of the hollow tube 10 from the wide portion 50 into the transition portion 45. The upward curve 49 represents the connection of the transition portion 45 to the narrow portion 40. If both the wide portion 50 and the narrow portion 40 are essentially cylindrical, such that the tube wall 15 of the hollow tube in the wide portion 50 is parallel to the tube wall 15 of the hollow tube 10 in the narrow portion 40, the inward curve 47 has the same angle of curvature θ as the upward curve 49, but in the opposite direction with respect to the length axis of the hollow tube 10. As specific examples, the angle of curvature θ may range from about 10° to about 80°, from about 20° to about 70°, from about 30° to about 60°, from about 35° to about 45° or from about 40° to about 50°.

The smooth curves described above result in a profile to the outside surface of the hollow tube 10 that allows any liquid encountering the outside surface to drain down freely. However, smooth curves are not critical to the proper operation of the device 1. In further embodiments not shown, the transition portion 45 also may define geometries including corners having angles of from about 10° to about 80°. Thus, in such embodiments the inward curve 47 and the upward curve 49 would be replaced by an inward corner and an upward corner, respectively. Alternatively, a plurality of corners could be present, for example, three, four, five, or six corners. Because only a small portion of liquid enters the inner column 20 and the liquid does not typically reach the transition portion 45, sharp corners do not adversely affect the operation of the device 1 for sensing and monitoring liquid levels.

As shown in FIG. 2, the hollow tube 10 has a lengthy from the first end 30 to the second end 35. The absolute magnitude of y is in no way critical to the function of the device 1, but in specific non-limiting examples, the lengthy may range from about 2 cm to about 2 m or even longer, depending only on the height of container in which the device 1 is intended to be used to measure a liquid level. In specific examples, y may range from about 5 cm to about 20 cm in devices for use in short containers or about 1.5 m to about 2 m in devices for use in tall containers.

Also as shown in FIG. 2, y₂ represents the length of the wide portion 50, as measured from the second end 35 to the boundary of the wide portion 50 with the transition portion 45. The length y₁ represents the length of the portion of the hollow tube 10 consisting of the wide portion 50 and the transition portion 45. As such, the length of the narrow portion 40 may be expressed as (y−y₁). Though the example embodiment shown in FIG. 2 has a ratio y₁/y₂ of about 1.4:1, in further non-limiting example embodiments, y₁/y₂ may range from about 1.05:1 to about 20:1 or from about 1.2:1 to about 1.6:1.

Depending in part on the size of container in which the device 1 is intended to be used for measuring a liquid level in the container, the ratio y₁/y may range from about 1:2 to about 1:100, from about 1:5 to about 1:50, from about 1:5 to about 1:25, from about 1:5 to about 1:15, or from about 1:10 to about 1:25. In a specific example, y₁/y may be about 1:10. In further embodiments, the ratio y₂/y may range from about 1:2 to about 1:100, from about 1:5 to about 1:50, from about 1:5 to about 1:25, from about 1:5 to about 1:15, or from about 1:10 to about 1:25. In a specific example, y₂/y may be about 1:10. In further specific non-limiting examples, y₁ may be in the range of 0.250 inches (0.635 cm) to 0.750 inches (1.91 cm), or for example, about 0.500″ (1.37 cm), for any hollow tube having lengthy in the range of about 2 inches (5.08 cm) to about 10 inches (25.4 cm). In still further non-limiting examples, y₂ may be chosen with consideration of expected ranges of liquid levels in a container in which the device 1 is intended to be used. Namely, y₂ may be chosen such that when the hollow tube 10 is immersed in a liquid in the intended container, y₂ would represent the highest anticipated level for the liquid that would result from filling of the container, expansion of the liquid due to pressure or temperature, or some other effect.

The ratios y₁/y , y₁/y₂, and x₂/x₁ may be chosen to optimize the accuracy of measurements that can be acquired by the device 1. Without intent to be limited by theory, it is believed that optimization of the shape of the hollow tube 10 through choice of the dimensional ratios involves both decreasing capillary forces within the hollow tube 10 and minimizing potential temperature effects. For example, a cylindrical hollow tube with or without narrow and wide portions naturally draws an amount of liquid into the hollow tube by capillary forces, such that the liquid level in the hollow tube is raised higher than it would have been if no capillary forces were present. The narrower the hollow tube, the more significant the capillary effects become, i.e., the more liquid drawn up into the hollow tube by the capillary forces, unrelated to the level of liquid in the container. Capillary effects are undesirable because they introduce discrepancies into the correlation of pressure inside the hollow tube and the liquid level in the container into which the hollow tube is immersed. But by simply increasing the inside diameter of the entire hollow tube, the capillary effects may be reduced or even eliminated.

Even so, if the inside diameter of a cylindrical hollow tube is made considerably larger, the hollow tube necessarily will contain a substantially higher volume of gas or air than when the inside diameter is much smaller, particularly when the entire hollow tube is made to have the considerably larger inside diameter, as opposed to a narrow portion and a wide portion. The higher volume of gas in the narrow tube then may become increasingly susceptible to error from significant changes in volume as a function of temperature. Namely, because pressure is directly proportional to temperature, a drop in temperature, for example, produces a proportional drop in pressure of the constant mass of gas in the hollow tube. The drop of pressure causes additional liquid to be drawn up into the hollow tube to equilibrate the hollow tube according to the P₁V₁=P₂V₂ relationship described above. Then, if the temperature rises again, the additional liquid may not be displaced out of the hollow tube completely. This may introduce errors into the measurement of air pressure and decrease the accuracy of the computation used to determine the fluid level in the container. As such, it is believed that construction of the hollow tube according to preferred embodiments described above, wherein the hollow tube comprises a narrow portion, a transition portion, and a wide portion, may be tailored in such a manner as to both minimize capillary effects without introducing significant temperature effects.

Referring to FIG. 3, the device 1 is shown in an example environment, in which the device 1 may be used to sense or monitor a liquid level 110 of a liquid 105 within a container 100. In FIG. 3, the device 1 is shown already inserted into the container 100 such that the second end 35 of the hollow tube 10 immersed in the liquid 105. As used herein, the term “immersed” means that at least the second end 35 of the hollow tube 10 is below the liquid level 110. One the second end 35 of the hollow tube 10 is immersed in the liquid 105, assuming a substantially air-tight connection is made between the hollow tube 10 and the pressure sensor body 5 and that the hollow tube 10 itself is substantially impervious to air, a volume of gas having a substantially constant mass will be trapped within the inner column 20.

For effective use of the device 1 to sense or monitor the liquid level 110, there are no particular requirements for the dimensions or configuration of the container 100 itself, except that the hollow tube 10 of the device 1 must be sufficiently long for the second end 35 of the hollow tube 10 to reach the liquid level 110 at any given time. However, in some intended uses it may be desirable to choose a hollow tube 10 such that the second end 35 is as close to the bottom of the container 100 as possible, for example, from 1 mm to 1 cm. Though FIG. 3 shows the container 100 as sealed and including a mounting feature 115 for resting the pressure sensor body 5 on the top, any type of container is appropriate for use with the device 1, including containers that are completely open on top.

Referring still to FIG. 3, while the second end 35 of the hollow tube 10 of the device 1 is immersed in the liquid 105, a small portion of the liquid 105 extends into the inner column 20, with arrows below the second end 35 illustrating the forces or flow driving up the small portion of the liquid 105. The liquid 105 may move freely into or out of the inner column 20 until an equilibrium condition is reached. Because the hollow tube 10 is a closed system, having a substantially air-tight connection to the pressure sensor body 5 and having walls of the hollow tube 10 that are substantially impervious to air, the liquid 105 extends into the inner column 20 only up to a column liquid level 120 correlated to the liquid level 110 within the container 100 but significantly below the liquid level 110 within the container 100. It will be understood that the column liquid level 120 need not comprise a flat liquid-gas interface with the inner column 20 as shown in FIG. 3. Namely, depending on the nature of the liquid 105 and the material of the hollow tube 10, the column liquid level 120 alternatively may be represented, for example, as a concave or convex meniscus in the liquid 105 centered at the second end 35 of the hollow tube 10. In the case of a convex meniscus extending into the inner column 20, it is possible even that no liquid 105 would contact any portion of the inside walls of the hollow tube 10 itself. Thus, the shape of the liquid-gas interface itself in no way diminishes or limits the scope of the device 1 operating on the principle that some portion of the liquid 105 extends into the inner column 20 to increase the pressure of the constant mass of gas contained in the inner column 20 above the pressure that was present when the second end 35 was not immersed. Moreover any change in the column liquid level 120 will cause a corresponding change in pressure to the substantially constant mass of gas present in the inner column 20. The change in pressure will be measurable by the sensing element 7 and directly related to the liquid level 110 of the liquid 105 in the container 100.

The column liquid level 120 in FIG. 3 is shown not to scale, at a slightly exaggerated height above the second end 35, and having a flat surface, to illustrate what is believed to be the principle of the device 1. For purposes of further illustration only, if the hollow tube 10 has an inside diameter of about 0.500 inches (12.7 mm) at the second end 35, the column liquid level 120 might be expected to be from about 0.010 inches (0.254 mm) to about 0.050 inches (1.27 mm), or even typically less than 0.040 inches (1.02 mm) above the second end 35 of the hollow tube 10, regardless of the liquid level 110 in the container 100. In any case, the column liquid level 120 also is significantly below the top of the wide portion 50 described above with respect to FIG. 2. As such, the geometric profile of the transition portion 45 is not critical to the proper function of the device 1 with regard to flow of liquid 105 into or out of the hollow tube 10 to produce a measurable pressure change. Though one illustrative example has been presented, it will be understood that the absolute height of the column liquid level 120 will vary depending on factors such as the liquid level 110 in the container 100 itself, the chemical and physical characteristics of the liquid 105, and ambient temperature and pressure conditions.

Extension of even the very small amount of the liquid 105 into the inner column 20 up to column liquid level 120 compresses a volume of gas contained within the inner column 20 and thereby increases the pressure of the volume of gas. Though the corresponding pressure increase would be very small as well, in preferred embodiments the sensing element 7 is selected such that the small pressure increase is within the detection limits of the sensing element. Entry of liquid 105 into the inner column 20 may occur, for example, when the device 1 is first inserted into the container 100 or when the device is already inserted and the liquid level 110 rises in response to a filling of the container 100 or a change of temperature or pressure inside or outside the container 100. Likewise, exiting of the liquid 105 from the inner column 20 may occur, for example, when the liquid level 110 falls in response to emptying of the container, to evaporation of some portion of the liquid 105 with or without subsequent venting, or to changes in temperature or pressure inside or outside the container 100.

The sensing element 7 is operable to measure either absolute pressure or changes in absolute pressure of the substantially constant mass of air or gas within the hollow tube 10. In preferred embodiments, the sensing element 7 may be operable to measure a differential pressure between the side of the sensing element 7 connected to the hollow tube 10 and the side of the sensing element 7 opposite the connection to the hollow tube 10 and exposed to the environment. This capability is useful for the sensing and monitoring of liquid levels in environments with decreased ambient air pressure such as, for example, at high altitudes. In all instances, the pressure so measured is directly related to the liquid level 110 as a function of the volume of the hollow tube, taking into consideration the cross-sectional areas of the wide portion 50, the transition portion 45, and the narrow portion 40. Thus, when properly calibrated and programmed, the device 1 may be operable to display very precise data corresponding to the liquid level 110 in the container 100. Calibration of the device 1 may require attention to the known geometry of the hollow tube 10 itself. Particularly, a calculation of the liquid level 110 from a measured pressure in the hollow tube 10 may require the sensing element 7 to be programmed with data indicating the volume of the hollow tube 10 below a given level, such as by an integral accounting for the cross-sectional areas of the hollow tube 10 at every point below the given level.

It is noted that terms such as “generally,” “commonly,” “typically,” and are not utilized herein to limit the scope of the claimed embodiments or to imply that certain features are critical, essential, or even important to the structure or function of the claimed embodiments. Rather, these terms are merely intended to highlight alternative or additional features that may or may not be utilized in any particular embodiment of the present disclosure. From the description of example embodiments in the present disclosure, it will be apparent that modifications and variations are possible without departing from the scope of the appended claims.

1. A device for sensing or monitoring a level of a liquid within a container, the device comprising:
a pressure sensor body comprising a sensing element; and
a hollow tube comprising:
a first end having a substantially air-tight connection to the pressure sensor body;
a second end opposite the first end;
a narrow portion extending from the first end and having a first inside diameter;
a wide portion extending from the second end and having a second inside diameter greater than the first inside diameter;
a transition portion connecting the narrow portion and the wide portion; and
an inner column defined within the hollow tube, the inner column being in fluid communication with the sensing element and extending from the first end to the second end,
such that while the second end of the hollow tube is immersed in the liquid, a portion of the liquid extends into the inner column up to a column liquid level, a change in the column liquid level causing a corresponding change in pressure to a substantially constant mass of gas contained within the inner column, the change in pressure being measurable by the sensing element and directly related to the level of the liquid in the container.

2. The device of claim 1, wherein both the wide portion and the narrow portion are essentially cylindrical.

3. The device of claim 1, wherein the ratio of the second inside diameter to the first inside diameter is from about 4:1 to about 10:1.

4. The device of claim 1, wherein the ratio of the second inside diameter to the first inside diameter is from about 4:1 to about 8:1.

5. The device of claim 1, wherein the ratio of the second inside diameter to the first inside diameter is about 6:1.

6. The device of claim 1, wherein the transition portion has a bell shape characterized a smooth upward curve and a smooth inward curve, each curve having an angle of curvature of from about 10° to about 80°.

7. The device of claim 6, wherein both the wide portion and the narrow portion are essentially cylindrical and both the smooth upward curve and the smooth inward curve have equal angles of curvature in opposite directions with respect to the length of the hollow tube.

8. The device of claim 6, wherein the angle of curvature is from about 30° to about 60°.

9. The device of claim 6, wherein the angle of curvature is from about 35° to about 45°.

10. The device of claim 1, wherein the transition portion comprises an inward corner and an upward corner, each corner having an angle of from about 10° to about 80°.

11. The device of claim 1, wherein the ratio of the combined lengths of the wide portion and the transition portion to the length of the wide portion is from about 1.05:1 to about 20:1.

12. The device of claim 1, wherein the ratio of the combined lengths of the wide portion and the transition portion to the length of the wide portion is from about 1.2:1 to about 1.6:1.

13. The device of claim 1, wherein the ratio of the combined lengths of the wide portion and the transition portion to the length of the hollow tube is from about 1:2 to about 1:100.

14. The device of claim 1, wherein the ratio of the combined lengths of the wide portion and the transition portion to the length of the hollow tube is from about 1:5 to about 1:15.

15. The device of claim 1, wherein the ratio of the length of the wide portion to the length of the hollow tube is about 1:10.

16. The device of claim 1, wherein the hollow tube comprises a chemically inert material.

17. The device of claim 1, wherein the hollow tube comprises a material substantially impervious to air.

18. The device of claim 1, wherein the hollow tube comprises polytetrafluoroethylene.

19. The device of claim 1, wherein the substantially air-tight connection comprises a connection element integral with the hollow tube, with the pressure sensor body, or both.

20. A device for sensing or monitoring a level of a liquid within a container, the device comprising:
a pressure sensor body comprising a sensing element; and
a hollow tube of a chemically inert material substantially impervious to air, the hollow tube defining a tube length, the hollow tube comprising:
a first end having a substantially air-tight connection to the pressure sensor body;
a second end opposite the first end;
an essentially cylindrical narrow portion extending from the first end and having a first inside diameter;
an essentially cylindrical wide portion extending from the second end and having a first length and a second inside diameter, such that the ratio of the second inside diameter to the first inside diameter is from about 4:1 to about 10:1;
a transition portion connecting the narrow portion and the wide portion and having a second length, such that the ratio of the sum of the second length and the first length to the first length is from about 1.2:1 to about 1.6:1 and the ratio of the sum of the second length and the first length to the tube length is from about 1:5 to about 1:15, the transition portion having a bell shape characterized a smooth upward curve and a smooth inward curve, the curves both having equal angles of curvature of from about 30° to about 60°; and
an inner column defined within the hollow tube, the inner column being in fluid communication with the sensing element and extending from the first end to the second end,
such that while the second end of the hollow tube is immersed in the liquid, a portion of the liquid extends into the inner column up to a column liquid level, a change in the column liquid level causing a corresponding change in pressure to a substantially constant mass of gas contained within the inner column, the change in pressure being measurable by the sensing element and directly related to the level of the liquid in the container.
